(19) United States
(12) Patent Application Publication
(10) Pub. No.: US 2024/0029493 A1
(43) Pub. Date: Jan. 25, 2024

(54) INFORMATION PROCESSING APPARATUS, INFORMATION PROCESSING METHOD, AND NON-TRANSITORY COMPUTER-READABLE STORAGE MEDIUM

(71) Applicant: NEC Corporation, Minato-ku, Tokyo (JP)

(72) Inventor: Yasuji SAITO, Tokyo (JP)

(73) Assignee: NEC Corporation, Minato-ku, Tokyo (JP)

(21) Appl. No.: 18/266,332

(22) PCT Filed: Dec. 18, 2020
(86) PCT No.: PCT/JP2020/047520

§ 371 Date: Jun. 9, 2023

(51) Int. Cl. G07C 9/30; G06F 3/14

(52) U.S. Cl. CPC G07C 9/30; G06F 3/14

(57) ABSTRACT

An information processing apparatus (100) includes: a connection information acquisition unit (120) that acquires connection information for communicating with a visited person terminal by processing an image captured by a camera included in a visitor terminal or communicating with a communication apparatus installed in a visited person house; and a visitor information transmission unit (122) that transmits visitor information being stored in advance to the visited person terminal by using the acquired connection information.

### TECHNICAL FIELD

The present invention relates to a visitor reception system, an information processing apparatus, an information processing method, and a program.

### BACKGROUND ART

One example of an intercom system having a function of calling and speaking to a resident is described in Patent Document 1. The intercom system in Patent Document 1 includes a face recognition unit that performs face recognition on a visitor, based on a captured image acquired from an intercom slave unit installed outside a house, and an output control unit that performs an output according to an authentication result to a master unit inside the house. With this configuration, reception appropriate for a resident is implemented by determining a visitor and thereby displaying a mark on a master unit, and not performing a calling operation of notifying a resident of a visit when face recognition fails.

Further, Patent Document 2 describes an intercom system including a slave unit that can read authentication data by communicating with a cellular phone possessed by a visitor, and a master unit including a display that displays a registration content when the read authentication data coincide with registered authentication data.

An intercom system described in Patent Document 3 includes a slave unit that performs infrared communication with a communication terminal apparatus possessed by a visitor, and receives identification information about the communication terminal apparatus, and a master unit that receives the identification information transferred from the slave unit, determines the visitor, based on the identification information, transmits, to the slave unit, an immediate reply being prepared by a visited person for the visitor, and instructs the slave unit to provide the immediate reply to the visitor.

Patent Document 4 describes a system for performing an identification inquiry of a visitor at a visit destination. A portable terminal of a visitor includes a non-contact IC card that records identification information about the visitor, and a biometric authentication functional unit that registers biometric identification information for authentication about the visitor. A visit reception apparatus reads the identification information from the non-contact IC card of the portable terminal of the visitor, instructs the biometric authentication functional unit to execute authentication, receives an authentication result, and changes information to be output to a screen display apparatus according to the result.

### RELATED DOCUMENTS

### Patent Documents

Patent Document 1: Japanese Patent Application Publication No. 2019-83468
Patent Document 2: Japanese Patent Application Publication No. 2003-224663
Patent Document 3: Japanese Patent Application Publication No. 2010-259015
Patent Document 4: Japanese Patent Application Publication No. 2009-26291

### SUMMARY OF INVENTION

### Technical Problem

In all of the systems described in the documents described above, a visitor is determined for a person scheduled for a visit. However, a person who is not scheduled for a visit is included in visitors. Thus, even when any of a person expected to visit and a person not expected to visit visits, it is desired that safety during reception can be secured.

The present invention has been made in view of the circumstance described above, and an object thereof is to be able to secure safety during reception even when any of a person expected to visit and a person not expected to visit visits.

### Solution to Problem

In each aspect according to the present invention, each configuration below is adopted in order to solve the above-mentioned problem.

A first aspect relates to an information processing apparatus.

A first information processing apparatus according to the first aspect is a computer that constitutes a visitor terminal held by a visitor, and includes:
an acquisition unit that acquires connection information for communicating with a visited person terminal by processing an image captured by a capturing unit included in the visitor terminal or communicating with a communication apparatus installed in a visited person house; and
a transmission unit that transmits visitor information being stored in advance to the visited person terminal by using the acquired connection information.

A second information processing apparatus according to the first aspect is a computer that constitutes a visited person terminal, and includes:
an acquisition unit that acquires visitor information from a visitor terminal;
a display processing unit that displays an image including the acquired visitor information on a screen; and
a transmission unit that transmits an unlocking command to an entranceway when an unlocking command of the entranceway is input after the image is displayed by the display processing unit.

A third information processing apparatus according to the first aspect is a computer that constitutes a visited person terminal held by a visited person, and includes:
a first acquisition unit that acquires connection information for communicating with a visitor terminal by processing an image captured by a capturing unit included in the visited person terminal; and
a second acquisition unit that requests and acquires visitor information from the visitor terminal by using the acquired connection information.

A second aspect relates to an information processing method executed by at least one computer.

The information processing method according to the second aspect is an information processing method implemented by each unit of any one of the first to third information processing apparatuses according to the first aspect described above.

Note that, another aspect according to the present invention may be a program causing at least one computer to execute each unit of any one of the first to third information processing apparatuses according to the first aspect described above, or may be a computer-readable storage medium that stores such a program. The storage medium includes a non-transitory tangible medium.

The computer program includes a computer program code causing a computer to execute the information processing method on the information processing apparatus when the computer program code is executed by the computer.

Note that, any combination of the components above and expression of the present invention being converted among a method, an apparatus, a system, a storage medium, a computer program, and the like are also effective as a manner of the present invention.

Further, various components according to the present invention do not necessarily need to be an individually independent presence, and a plurality of components may be formed as one member, one component may be formed of a plurality of members, a certain component may be a part of another component, a part of a certain component and a part of another component may overlap each other, and the like.

Further, a plurality of procedures are described in order in the method and the computer program according to the present invention, but the described order does not limit an order in which the plurality of procedures are executed. Thus, when the method and the computer program according to the present invention are executed, an order of the plurality of procedures can be changed within an extent that there is no harm.

Furthermore, a plurality of procedures of the method and the computer program according to the present invention are not limited to being executed at individually different timings. Thus, another procedure may occur during execution of a certain procedure, an execution timing of a certain procedure and an execution timing of another procedure may partially or entirely overlap each other, and the like.

### Advantageous Effects of Invention

According to each of the aspects described above, even when any of a person expected to visit and a person not expected to visit visits, safety during reception can be secured.

### BRIEF DESCRIPTION OF THE DRAWINGS

FIG. 1 It is a diagram illustrating a usage example of a visitor reception system according to an example embodiment of the present invention.

FIG. 2 It is a block diagram illustrating a hardware configuration of a computer constituting an information processing apparatus that implements a visitor terminal and a visited person terminal.

FIG. 3 It is a functional block diagram logically illustrating a configuration of the information processing apparatus (visitor terminal) according to the present example embodiment.

FIG. 4 It is a diagram illustrating a communication distance (effective range) of Bluetooth (registered trademark).

FIG. 5 It is a flowchart illustrating one example of an operation of the information processing apparatus (visitor terminal) according to the present example embodiment.

FIG. 6 It is a diagram illustrating a usage example of the visitor reception system according to the present example embodiment.

FIG. 7 It is a functional block diagram illustrating a logical configuration example of the information processing apparatus (visited person terminal) according to the present example embodiment.

FIG. 8 It is a flowchart illustrating one example of an operation of the information processing apparatus (visited person terminal) according to the present example embodiment.

FIG. 9 It is a diagram illustrating a usage example of a visitor reception system 1 according to the present example embodiment.

FIG. 10 It is a functional block diagram illustrating a logical configuration example of the information processing apparatus (visitor terminal) according to the present example embodiment.

FIG. 11 It is a diagram illustrating a usage example of the visitor reception system according to the present example embodiment.

FIG. 12 It is a functional block diagram illustrating a functional configuration example of the information processing apparatus (a portable terminal of a visited person or an intercom master unit) according to the present example embodiment.

FIG. 13 It is a diagram illustrating a first usage example of the visitor reception system according to the present example embodiment.

FIG. 14 It is a diagram illustrating a second usage example of the visitor reception system according to the present example embodiment.

FIG. 15 It is a diagram illustrating a usage example of the visitor reception system according to the present example embodiment.

FIG. 16 It is a functional block diagram illustrating a logical configuration example of the information processing apparatus (visited person terminal) according to the present example embodiment.

FIG. 17 It is a diagram illustrating a usage example of the visitor reception system according to the present example embodiment.

FIG. 18 It is a diagram illustrating a usage example of the visitor reception system according to the present example embodiment.

FIG. 19 It is a diagram illustrating an example of a procedure of personal registration and personal identification.

FIG. 20 It is a diagram illustrating visitor information registered in the visitor terminal.

### EXAMPLE EMBODIMENT

Hereinafter, example embodiments of the present invention will be described with reference to the drawings. Note that, in all of the drawings, a similar component has a similar reference sign, and description thereof will be not appropriately included. Further, in each of the following drawings, a configuration of a portion unrelated to essence of the present invention is not included and not illustrated.

“Acquisition” in an example embodiment includes at least one of acquisition (active acquisition), by its own apparatus, of data or information being stored in another apparatus or a storage medium, and inputting (passive acquisition) of data or information output from another apparatus to its own apparatus. Examples of the active acquisition include reception of a reply by making a request or an inquiry to another apparatus, reading by accessing another apparatus or a storage medium, and the like. Further, examples of the passive acquisition include reception of information to be distributed (transmitted, push-notified, or the like), and the like. Furthermore, “acquisition” may include acquisition by selection from among pieces of received data or pieces of received information, or reception by selecting distributed data or distributed information.

### First Example Embodiment

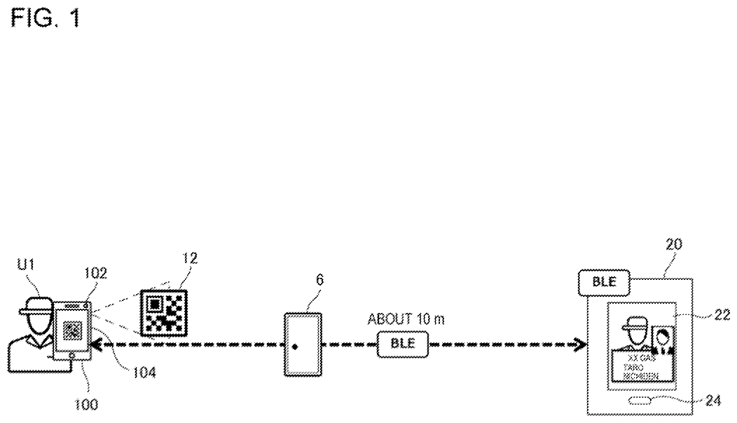

FIG. 1 is a diagram illustrating a usage example of a visitor reception system 1 according to an example embodiment of the present invention. The visitor reception system 1 includes a visitor terminal 100 used by a visitor, and an intercom master unit 20 installed inside a house. The visitor terminal 100 is a portable-type portable terminal such as a smartphone, a tablet terminal, a cellular phone, and a personal digital assistant (PDA), for example. The visitor terminal 100 may be possessed by a visitor or may be lent. The visitor terminal 100 includes a camera 102, a display 104, and a communication unit (not illustrated) that performs short-distance communication such as Bluetooth (registered trademark) (particularly, Bluetooth low energy (BLE)).

In a visited person house, the intercom master unit 20 is installed inside the house, and an intercom slave unit 10 (not illustrated in FIG. 1) is installed outside the house. A two-dimensional code such as a quick response (QR) code (registered trademark) 12 is attached to the slave unit 10 or around the slave unit 10. The master unit 20 includes a display 22 and a conversation button 24.

A visitor U1 acquires connection information recorded in the QR code 12 by capturing the QR code 12 by using the camera 102 of the visitor terminal 100. The connection information includes information needed for the visitor terminal 100 to perform communication with the master unit 20.

In another example, the visitor terminal 100 may read and acquire, by Near Field Communication (NFC), connection information recorded in a storage medium such as a non-contact IC card installed in the slave unit 10 in the visited person house or around the slave unit 10.

### Hardware Configuration Example

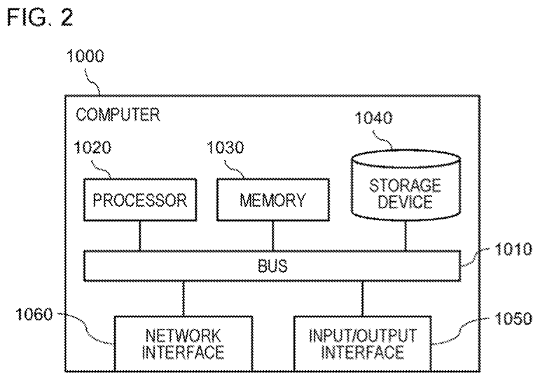

FIG. 2 is a block diagram illustrating a hardware configuration of a computer 1000 constituting an information processing apparatus that implements the visitor terminal 100 and a visited person terminal 210 (including the portable terminal 200 of a visited person and the intercom master unit 20). Furthermore, the intercom slave unit 10 is also implemented by the computer 1000. Hereinafter, the visitor terminal 100 and the visited person terminal 210 are also referred to as the information processing apparatus 100 and the information processing apparatus 210.

The computer 1000 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method for connecting the processor 1020 and the like to one another is not limited to bus connection.

The processor 1020 is a processor implemented by a central processing unit (CPU), a graphics processing unit (GPU), and the like.

The memory 1030 is a main storage apparatus implemented by a random access memory (RAM) and the like.

The storage device 1040 is an auxiliary storage apparatus implemented by a hard disk drive (HDD), a solid state drive (SSD), a memory card, a read only memory (ROM), or the like. The storage device 1040 stores a program module that implements each function (for example, a connection information acquisition unit 120, a visitor information transmission unit 122, a visitor information acquisition unit 220, a display processing unit 222, an unlocking command transmission unit 224, a control unit 226, and the like described below) of the visitor terminal 100, the master unit 20, and the portable terminal 200 of the visited person. The processor 1020 reads each program module onto the memory 1030 and executes the program module, and each function associated with the program module is implemented. Further, the storage device 1040 may also store each piece of data of the visitor terminal 100, the visited person terminal 210, and the like.

The program module may be stored in a storage medium. The storage medium that stores the program module may include a non-transitory tangible medium usable by the computer 1000, and a program code readable by the computer 1000 (the processor 1020) may be embedded in the medium.

The input/output interface 1050 is an interface for connecting the computer 1000 and various types of input/output equipment. The input/output interface 1050 also functions as a communication interface that performs short-range wireless communication, such as Bluetooth (registered trademark) and Near Field Communication (NFC).

The network interface 1060 is an interface for connecting the computer 1000 to a communication network. The communication network is, for example, a local area network (LAN) and a wide area network (WAN). A method of connection to the communication network by the network interface 1060 may be wireless connection or wired connection.

Then, the computer 1000 is connected to necessary equipment (for example, the camera 102 and the display 104 of the visitor terminal 100, a display 202, a speaker, and a microphone of the visited person terminal 210, the display 22, the conversation button 24, a speaker, and a microphone of the master unit 20, the intercom slave unit 10, or the like) via the input/output interface 1050 or the network interface 1060.

The display 104 and the display 202 of the visitor terminal 100 and the visited person terminal 210 are, for example, a liquid crystal display, an organic electro luminescence (EL) display, and the like, and may be a touch panel integrated with a reception means for receiving an operation of a user.

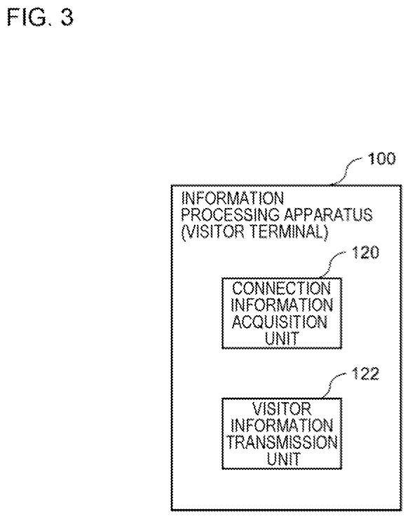

FIG. 3 is a functional block diagram logically illustrating a configuration of the information processing apparatus (visitor terminal) 100 according to the present example embodiment. Each component of the information processing apparatus (visitor terminal) 100 in FIG. 3 is implemented by any combination of hardware of the computer 1000 in FIG. 2 and software. Then, various modification examples of an implementing method and an apparatus thereof are understood by a person skilled in the art. A functional block diagram illustrating the information processing apparatus (visitor terminal) 100 according to each example embodiment described below illustrates a block of logical functional units instead of a configuration of hardware units.

An application that implements the information processing apparatus 100 is installed in the visitor terminal 100, and each function of each component of the information processing apparatus 100 in FIG. 3 is implemented by activating the application. Alternatively, by activating a browser in the visitor terminal 100 and logging into a predetermined Web site, each function of each component of the information processing apparatus 100 in FIG. 3 may be implemented on the visitor terminal 100 by a program executed on a server (not illustrated).

Further, also in a case of an application use, a user is preferably registered in advance, and the application may be usable after a login to the visitor reception system 1 by using user registration information. Further, for use of the visitor terminal 100 or the application, use of the visitor terminal 100 or the application is preferably implemented when comparison with biometric authentication information being already registered in advance is performed and authentication succeeds.

The biometric authentication information includes, for example, at least any one of an iris, a vein, an auricle, a fingerprint, a voiceprint, and the like. The authentication apparatus (not illustrated) extracts a feature value of the biometric authentication information from an image captured by the camera 102 or a sound collected from the microphone, and performs authentication processing by performing comparison with the biometric authentication information about the user of the visitor terminal 100 being already registered in advance.

The visitor terminal 100 includes the connection information acquisition unit 120 and the visitor information transmission unit 122.

The connection information acquisition unit 120 acquires connection information for communicating with the visited person terminal 210 (the intercom master unit 20 in FIG. 1) by processing an image captured by the camera 102 included in the visitor terminal 100 or communicating with a communication apparatus (not illustrated) installed in the visited person house.

The visitor information transmission unit 122 transmits visitor information being stored in advance to the visited person terminal 210 (the intercom master unit 20 in FIG. 1) by using the acquired connection information.

The connection information for communicating with the visited person terminal 210 (the intercom master unit 20 in FIG. 1) is information for short-range wireless communication.

The short-range wireless communication is, for example, Bluetooth (registered trademark) and the like, which is not limited thereto. The connection information includes information needed to establish communication between the visited person terminal 210 (at least one of the portable terminal 200 of the visited person and the intercom master unit 20) and the visitor terminal 100, and identification information about the visited person terminal 210 (at least one of the portable terminal 200 of the visited person and the intercom master unit 20).

However, in order to cause the intercom master unit 20 to function as the visited person terminal 210, a program having a function of the visited person terminal 210 needs to be stored in the memory 1030 in an executable state by the processor 1020 of the intercom master unit 20. In other words, the intercom master unit 20 needs to be associated with the present visitor reception system 1. When the intercom master unit 20 is not associated with the visitor reception system 1, the portable terminal 200 of the visited person is used as the visited person terminal 210.

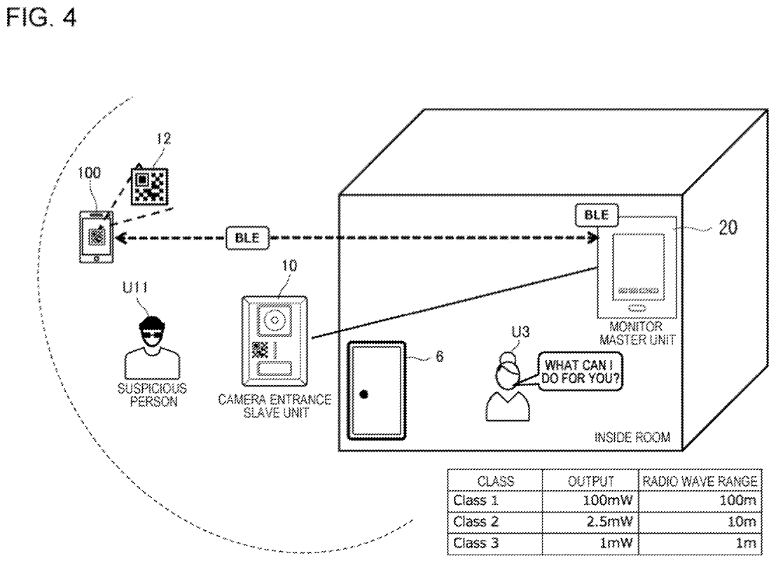

As illustrated in FIG. 4, Bluetooth has a communication range (effective range) determined for each class. Class 1 has a maximum output of 100 mW and a communication distance of approximately 100 m, Class 2 has a maximum output of 2.5 mW and a communication distance of approximately 10 m, and Class 3 has a maximum output of 1 mV and a communication distance of approximately 1 m. In the present example embodiment, Class 2 having a communication distance reaching from an entrance of a general house to the inside of a room of a building is preferably used.

The visitor terminal 100 in which the application of the visitor reception system 1 is installed can communicate with the intercom master unit 20 in the visited person house by using connection information, but a suspicious person U11 operates the intercom slave unit 10 without using the visitor terminal 100, and thus visitor information cannot be transmitted to the intercom master unit 20 unlike the visitor terminal 100. Thus, a visited person U3 can distinguish between a visitor who uses the application of the visitor reception system 1 and a visitor who does not use the application. Then, a visitor (suspicious person U11) who does not use the visitor reception system 1 can be dealt with by an automatic response or without opening a door 6.

As illustrated in FIG. 1, in the present example embodiment, an image captured by the camera 102 includes at least code information indicating connection information. For example, the image is a two-dimensional code such as the QR code 12 indicating connection information. The QR code 12 is attached to the intercom slave unit 10 installed on an entrance or a gate of a visited person house, or around the slave unit 10, for example.

By capturing an image of the QR code 12 by using the camera 102 of the visitor terminal 100, and processing the image, the connection information acquisition unit 120 can acquire the connection information recorded in the QR code 12.

The visitor information transmission unit 122 establishes communication with the visited person terminal 210 (the intercom master unit 20 in FIG. 1) by using the connection information acquired by the connection information acquisition unit 120. Visitor information transmitted from the visitor terminal 100 is information about a person authenticated to be valid as a user of the visitor terminal 100, and is stored in advance in the memory 1030 of the visitor terminal 100. The visitor information preferably includes, for example, an image of a visitor, particularly a face image. The face image is preferably stored in advance in the memory 1030 of the visitor terminal 100. More preferably, the face image is a face image authenticated by electronic know your customer (eKYC) and stored in the memory 1030 of the visitor terminal 100.

The visitor information may include at least one of belonging (for example, a company name, a store name, a group name, a company code, information about a type of business, and the like) of a user of the visitor terminal 100, and a name (for example, may not be a real name, and may be a business name or a nickname). Furthermore, the visitor information may include various types of certificate information about a user of the visitor terminal 100. The certificate information may include, for example, various types of qualification information, such as information indicating possession of a qualification related to a technician such as electrical work and a qualification related to a technician such as an inspection of gas and water, information certifying that a person is not contracting an infectious disease (may also include information such as an antibody check result, an antigen check result, and vaccine injection information), information about a passage history, or the like.

The visitor information transmission unit 122 transmits a face image of a visitor to the visited person terminal 210 (the intercom master unit 20 in FIG. 1). The visited person terminal 210 (the intercom master unit 20 in FIG. 1) can display the received face image on the display 202 or the display 22. An operation of the visited person terminal 210 (the intercom master unit 20 in FIG. 1) will be described in an example embodiment described below.

### Operation Example

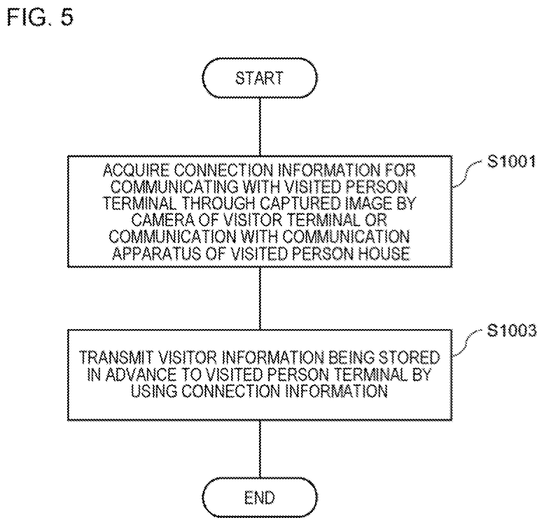

FIG. 5 is a flowchart illustrating one example of an operation of the information processing apparatus (visitor terminal) 100 according to the present example embodiment.

First, when the visitor U1 visits a visited person house, the visitor U1 activates the application of the visitor reception system 1 in the visitor terminal 100. Then, in order to read the QR code 12 attached to the slave unit 10 installed outside the visited person house or around the slave unit 10, the connection information acquisition unit 120 activates the camera 102 of the visitor terminal 100, and outputs a guidance (a screen display and/or a sound output) for reading the QR code 12. When the visitor U1 operates the visitor terminal 100 and captures the QR code 12 according to the guidance, the connection information acquisition unit 120 processes the captured image of the QR code 12, and acquires connection information from the QR code 12 (step S1001).

Alternatively, the connection information acquisition unit 120 may acquire the connection information through NFC communication with a communication apparatus (for example, a non-contact IC card) provided on the visited person house.

Then, the visitor information transmission unit 122 establishes communication with the visited person terminal 210 (the intercom master unit 20 in FIG. 1) by using the connection information acquired in step S1001, and transmits visitor information being stored in advance in the memory 1030 of the visitor terminal 100 to the visited person terminal 210 (the intercom master unit 20 in FIG. 1) (step S1003).

The visited person terminal 210 (the intercom master unit 20 in FIG. 1) receives the visitor information, and can display the visitor information on the display 202 or the intercom master unit 20. In this way, the visited person U3 can confirm, as information about a person who visits in front of an entrance, the visitor information being stored in advance in the visitor terminal 100. The visitor information is, for example, a face image authenticated by eKYC in advance, and thus indicates a person being valid as a user of the visitor terminal 100.

As described above, according to the present example embodiment, the connection information acquisition unit 120 acquires connection information for communicating with the visited person terminal 210 from the QR code 12, and the visitor information transmission unit 122 transmits visitor information to the visited person terminal 210 by using the connection information, and thus the visitor information acquisition unit 220 receives the visitor information transmitted from the visitor terminal 100, and the display processing unit 222 displays the visitor information on the display 22.

In this way, the visited person U3 can confirm the information about the visitor U1 being displayed on the intercom master unit 20 and deal with the visitor U1. In this way, even when any of a person expected to visit and a person not expected to visit visits, the visitor information is transmitted to the visited person terminal 210 by using the visitor terminal 100, and thus safety during reception can be secured. Further, a person who calls without communicating with the visited person terminal 210 can be recognized as the suspicious person U11, and thus an appropriate response such as not dealing with the suspicious person U11 can be selected.

Further, since only the connection information is acquired from the QR code 12, personal information about the visited person U3 is not included and an individual is not determined by an outside, and thus safety can be guaranteed.

### Second Example Embodiment

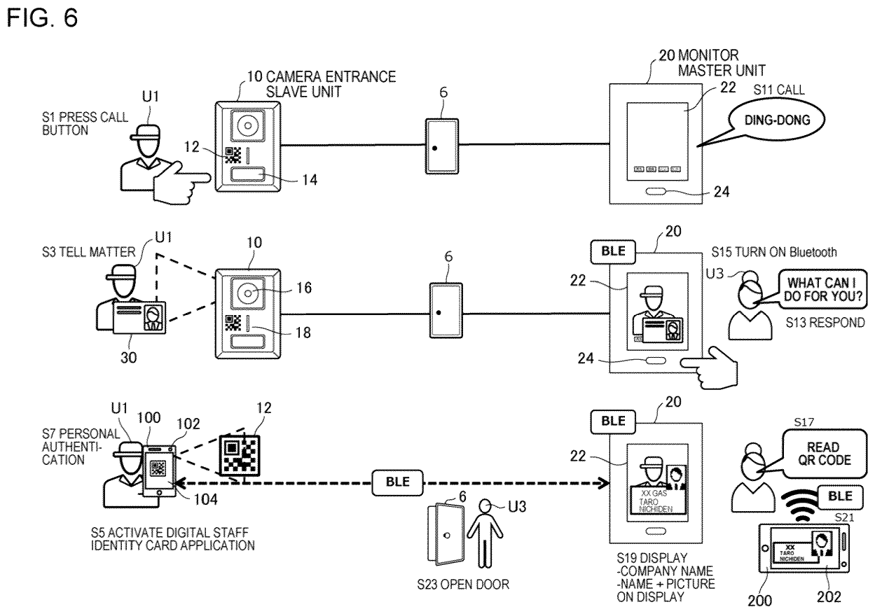

FIG. 6 is a diagram illustrating a usage example of a visitor reception system 1 according to the present example embodiment.

In the present example embodiment, a configuration of at least one of a portable terminal 200 of a visited person and an intercom master unit 20 in the visitor reception system 1 will be described.

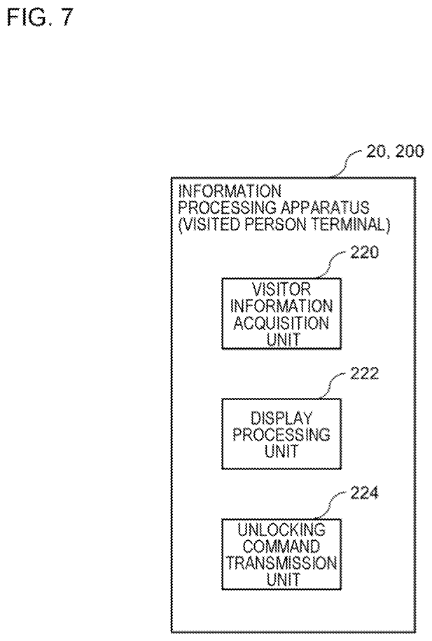

FIG. 7 is a functional block diagram illustrating a logical configuration example of an information processing apparatus 210 (the portable terminal 200 of the visited person or the intercom master unit 20) according to the present example embodiment. Each component of the information processing apparatus 210 (the portable terminal 200 of the visited person or the intercom master unit 20) in FIG. 7 is implemented by any combination of hardware of the computer 1000 in FIG. 2 and software. Then, various modification examples of an implementing method and an apparatus thereof are understood by a person skilled in the art. A functional block diagram illustrating the information processing apparatus 210 (the portable terminal 200 of the visited person or the intercom master unit 20) according to each example embodiment described below illustrates a block of logical functional units instead of a configuration of hardware units.

An application that implements the information processing apparatus 210 is installed in the portable terminal 200 of the visited person, and each function of each component of the information processing apparatus 210 in FIG. 7 is implemented by activating the application. Alternatively, by activating a browser in the portable terminal 200 of the visited person and logging into a predetermined Web site, each function of each component of the information processing apparatus 210 in FIG. 7 may be implemented on the portable terminal 200 of the visited person by a program executed on a server (not illustrated).

The information processing apparatus 210 (the portable terminal 200 of the visited person or the intercom master unit 20) includes a visitor information acquisition unit 220, a display processing unit 222, and an unlocking command transmission unit 224.

The visitor information acquisition unit 220 acquires visitor information from a visitor terminal 100.

The display processing unit 222 displays an image including the visitor information acquired by the visitor information acquisition unit 220 on a screen (a display 202 or a display 22).

When an unlocking command of an entranceway (door 6) is input after the image is displayed by the display processing unit 222, the unlocking command transmission unit 224 transmits the unlocking command to the entranceway.

However, the unlocking command transmission unit 224 is not necessarily needed. When a visited person U3 can confirm a visitor U1, the visited person U3 may go to the door 6 and manually unlock the door 6.

### Operation Example

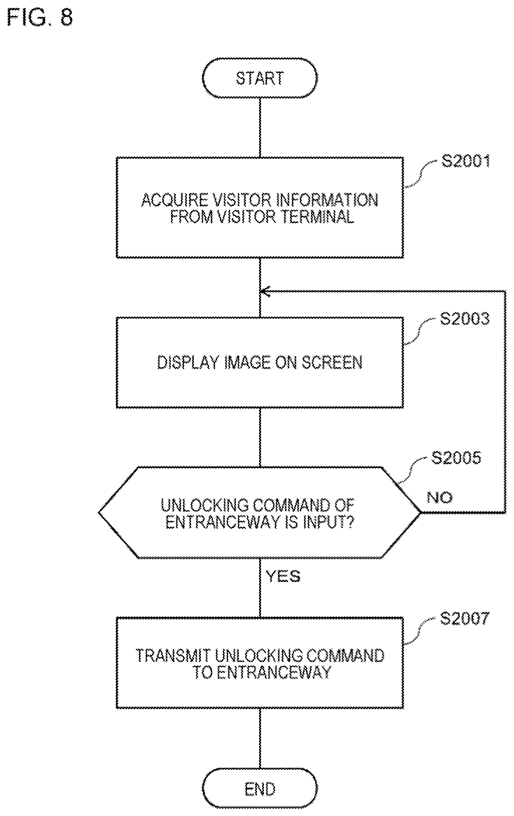

FIG. 8 is a flowchart illustrating one example of an operation of the information processing apparatus 210 (the portable terminal 200 of the visited person or the intercom master unit 20) according to the present example embodiment. Hereinafter, description is given by using FIGS. 6 to 8.

First, an application of the visitor reception system 1 is activated in advance in the portable terminal 200 of the visited person. When the visitor U1 visits a visited person house and presses a call button 14 of an intercom slave unit 10 (step S1 in FIG. 6), the intercom master unit 20 outputs a call sound from a speaker (step S11 in FIG. 6).

When the visited person U3 presses a conversation button 24 of the intercom master unit 20 and deals with the call of the visitor U1 over the master unit 20 (step S13), the visitor U1 tells the visited person U3 an important matter over the slave unit 10 (step S3). At this time, the slave unit 10 captures the visitor U1 by a camera 16, and displays a captured image on the display 22 of the master unit 20. At this time, for example, the visitor U1 may provide an identification card of himself/herself, for example, a staff identity card 30 or the like to the camera 16. The visited person U3 can visually confirm a face image and the staff identity card of the visitor U1 being displayed on the display 22 of the intercom master unit 20. Up to this point, it is a reception method between the visitor U1 and the visited person U3 in a general intercom system.

When the visited person U3 presses the conversation button 24, the master unit 20 further activates a short-range communication function such as Bluetooth, and is in a waiting state of a connection request from another apparatus (step S15). The visited person U3 requests the visitor U1 to read a QR code 12 over the master unit 20 (step S17).

As described in the first example embodiment, the visitor U1 activates the application (described as a “digital staff” identity card application in FIG. 6) of the visitor reception system 1 in the visitor terminal 100 (step S5). At this time, it is preferable that the visitor terminal 100 performs biometric authentication processing such as face authentication, and, when authentication succeeds, the visitor terminal 100 is in a usable state.

Then, as described in the first example embodiment, the visitor U1 reads the QR code 12 according to a guidance of the application by the visitor terminal 100, acquires connection information with the master unit 20, establishes communication with the master unit 20, and transmits visitor information to the master unit 20. In the present example embodiment, the series of procedure is also referred to as “personal authentication” (step S7).

The master unit 20 establishes connection with the visitor terminal 100 in response to the connection request from the visitor terminal 100, then receives the visitor information transmitted from the visitor terminal 100, and displays the received visitor information on the display 22 (step S19).

The display processing unit 222 displays, on the same screen on the display 22, the face image of the visitor U1 captured by the camera 16 of the slave unit 10 and a face picture included in the visitor information received from the visitor terminal 100. The two images may be displayed side by side, or the face picture included in the visitor information may be displayed over the face image of the visitor U1 captured by the camera 16 of the slave unit 10.

The display 22 displays the face image of the visitor U1 captured by the camera 16 of the slave unit 10 and the visitor information (such as a company name, a name, and a face picture) received from the visitor terminal 100. At this time, the portable terminal 200 of the visited person U3 may also establish connection with the visitor terminal 100, receive the visitor information from the visitor terminal 100, and transmit the visitor information to the display 202. Then, the visitor information received from the visitor terminal 100 is displayed on the display 202 of the portable terminal 200 of the visited person U3 (step S21).

In FIG. 8, the visitor information acquisition unit 220 acquires visitor information from the visitor terminal 100 (step S2001). Then, the display processing unit 222 displays an image including the acquired visitor information on the display 22 or the display 202 (step S2003). When the display processing unit 222 displays the image in step S2003, and the unlocking command transmission unit 224 then receives an input of an unlocking command of an entranceway (door 6) (YES in step S2005), the unlocking command transmission unit 224 transmits the unlocking command to the entranceway (step S2007).

In this way, the intercom master unit 20 can receive the captured image of the visitor U1 who actually visits the visited person house and the visitor information registered in advance in the visitor terminal 100, and display the captured image and the visitor information on the display 22. Then, the visited person U3 can confirm, on the screen of the display 22 of the intercom master unit 20, whether the visitor U1 is a person (i.e., the person concerned) coinciding with the visitor information transmitted from the visitor terminal 100.

According to the present example embodiment, the display processing unit 222 can display, on the same screen, a face picture that is recorded in advance in the visitor terminal 100 and has already been subjected to personal authentication and an image acquired by capturing a person who actually visits by the intercom slave unit 10, and thus unauthorized behavior such as spoofing can be confirmed by the screen when the unauthorized behavior is performed.

### Third Example Embodiment

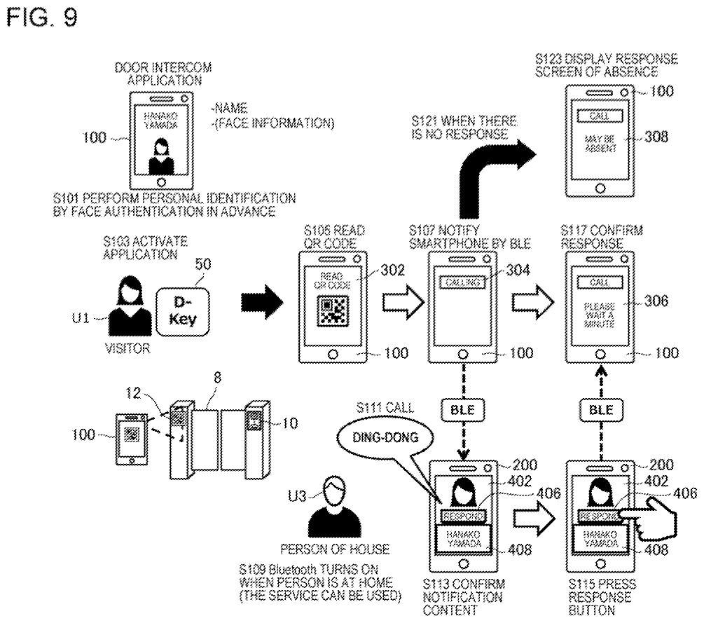

FIG. 9 is a diagram illustrating a usage example of a visitor reception system 1 according to the present example embodiment. The present example embodiment is the same as the example embodiments described above except for a point that the present example embodiment has a configuration capable of dealing even when a visited person U3 is absent, and the like. Note that, the configuration of the present example embodiment can be combined as long as the present example embodiment is not inconsistent with at least any one of configurations of other example embodiments.

### Functional Configuration Example

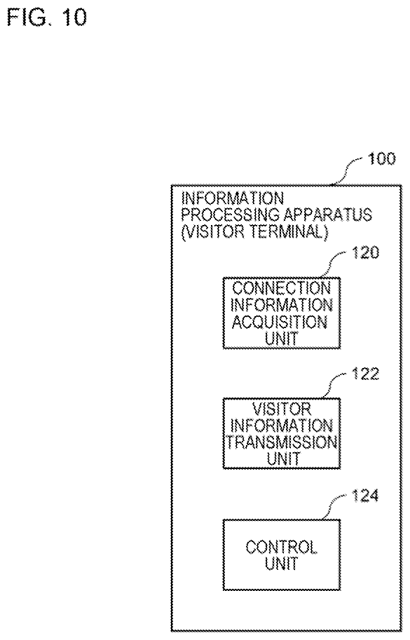

FIG. 10 is a functional block diagram illustrating a logical configuration example of an information processing apparatus 100 according to the present example embodiment. The information processing apparatus 100 according to the present example embodiment further includes a control unit 124 in addition to the configuration of the information processing apparatus 100 according to the example embodiment described above in FIG. 3.

The control unit 124 changes display information or a processing content according to belonging of a visitor. For example, the control unit 124 displays a predetermined screen on a display 104 when visitor information is transmitted to a portable terminal 200 of a visited person and then there is no response from the portable terminal 200 of the visited person. At this time, the control unit 124 changes the predetermined screen to be displayed according to belonging of a visitor.

For example, when belonging of a visitor indicates an acquaintance, the predetermined screen includes a message notifying that the visited person is absent. Furthermore, a user interface (UI) such as an operation button that receives an operation for notifying the portable terminal 200 of the visited person of a matter to the absent visited person and the like as a message may be included. Furthermore, for example, when belonging of a visitor indicates a home-delivery company, the predetermined screen includes a message that requests a package to be placed into a delivery box. Further, when belonging of a visitor indicates a newspaper salesman, the predetermined screen may not be displayed. A specific example will be described in an example embodiment described below.

The control unit 124 can determine belonging of a visitor, based on visitor information (for example, a company code and the like) that has already been subjected to personal identification, identification information about an application installed in the visitor terminal 100, or the like. Alternatively, display information and a processing content may be decided for each application.

### Operation Example

An operation of the information processing apparatus 210 will be described by using FIG. 9. In FIG. 9, the information processing apparatus 210 is described with the portable terminal 200 of the visited person U3 as an example. However, the information processing apparatus 210 may be an intercom master unit 20, and is at least one of the portable terminal 200 of the visited person U3 and the intercom master unit 20.

First, an application of the visitor reception system 1 is activated in advance in the portable terminal 200 of the visited person U3. A visitor U1 installs an application (described as a “door intercom application” in FIG. 9) of the visitor reception system 1 in advance in the portable terminal 100. Then, the visitor U1 performs personal identification by face authentication on the visitor terminal 100 at a time of a visit (step S101), and, when the authentication succeeds, the visitor terminal 100 can be used. Then, the door intercom application is activated by the visitor terminal 100 (step S103).

Then, the visitor U1 captures and reads a QR code 12 installed near a gate 8 of a visited person house by a camera 102 according to a guidance of the visitor terminal 100 (step S105). A QR code reading screen 302 is displayed on the visitor terminal 100. In the visitor terminal 100, a connection information acquisition unit 120 acquires connection information from the QR code 12, and a visitor information transmission unit 122 makes a connection request with the portable terminal 200 of the visited person U3 by using the connection information acquired by the connection information acquisition unit 120 (step S107). At this time, the control unit 124 of the visitor terminal 100 may display a call screen 304 on the display 104.

Then, when the visited person U3 is at home, and communication between the visitor terminal 100 and the portable terminal 200 of the visited person U3 is established (step S109), the visitor terminal 100 transmits visitor information to the portable terminal 200 of the visited person U3, and causes the portable terminal 200 of the visited person U3 to perform an output (an output of a call sound or a display of a call screen 402) for calling the visited person U3 (step S111). The call screen 402 displays fewer face pictures of the visitor U1 included in the visitor information received from the visitor terminal 100. Furthermore, the call screen 402 may include a response button 406 for the visited person U3 to respond, and a visitor information display portion 408 that displays information, such as a name of the visitor U1, included in the visitor information.

When the visited person U3 confirms a notification content of the call screen 402 (step S113), and presses the response button 406 (step S115), a response notification is transmitted from the portable terminal 200 of the visited person U3 to the visitor terminal 100. In the visitor terminal 100, the control unit 124 displays, on the display 104, a home response screen 306 indicating a content of the response notification received from the portable terminal 200 of the visited person U3. The visitor U1 confirms the response content (step S117). A content of the response notification may include a content indicating that the visited person U3 is at home, such as “Please wait a minute.”, for example. Alternatively, the content may include a content indicating that the visited person U3 is at home but cannot deal, such as “I am not available since I am currently busy.”. Furthermore, the content may include a content causing the visitor U1 to record a matter, such as “Please tell me what brings you here.”, for example. Then, the portable terminal 200 of the visited person U3 may receive sound data about the visitor U1 from the visitor terminal 100, and record the sound data in association with the visitor information.

On the other hand, when the visited person U3 is absent, the portable terminal 200 of the visited person U3 does not respond to the connection request from the visitor terminal 100. Thus, when there is no response for a predetermined period of time or longer in the visitor terminal 100 (step S121), the control unit 124 displays, on the display 104, an absence response screen 308 indicating a possibility of absence of the visited person U3 (step S123).

According to the present example embodiment, the visited person U3 can confirm, on the call screen 402, the visitor information about the visitor U1 being displayed by a display processing unit 222, and then deal with the visitor U1. Furthermore, in the visitor terminal 100, when the visited person U3 is absent, the control unit 124 can detect absence of a response and display the absence response screen 308 on the display 104 of the visitor terminal 100.

### Fourth Example Embodiment

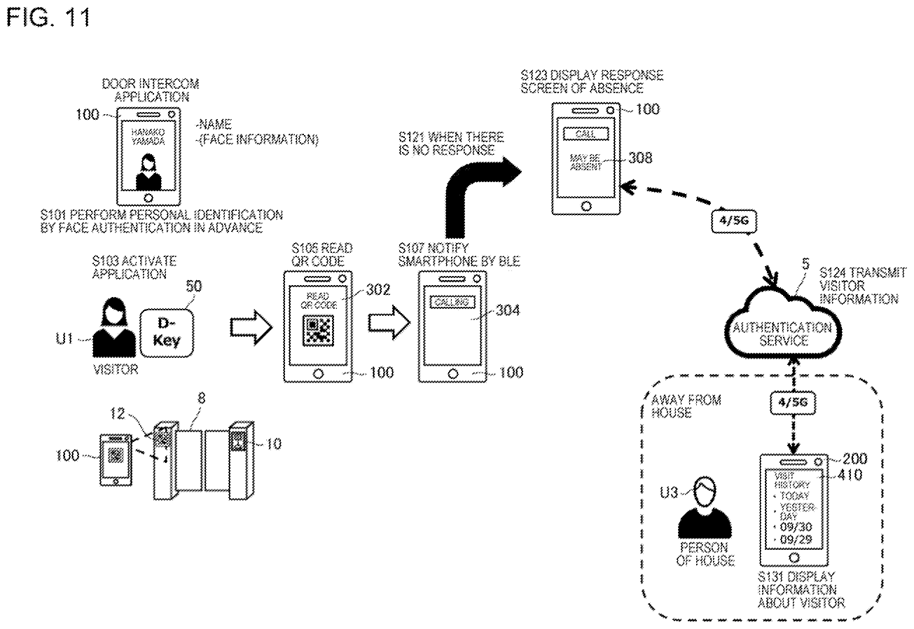

FIG. 11 is a diagram illustrating a usage example of a visitor reception system 1 according to the present example embodiment. The present example embodiment is the same as the third example embodiment described above except for a point that the present example embodiment has a configuration for notifying a portable terminal 200 of a visited person U3 when the visited person U3 goes out, and the like. A visitor terminal 100 will be described by using FIG. 10. An information processing apparatus 210 will be described by using FIG. 7. Note that, the configuration of the present example embodiment can be combined as long as the present example embodiment is not inconsistent with at least any one of configurations of other example embodiments.

When a visitor information transmission unit 122 of the visitor terminal 100 transmits visitor information to the portable terminal 200 of the visited person U3, and there is no response from the portable terminal 200 of the visited person U3, the visitor information is further transmitted to an authentication service server 5 via a communication network 2 such as a cellular phone communication network.

A situation where there is no response from the portable terminal 200 of the visited person U3 is when the visited person U3 is absent, or is at home but cannot respond since the visited person U3 is in the middle of something. As described above, the visitor terminal 100 establishes connection with the visited person terminal 210 (at least any one of an intercom master unit 20 and the portable terminal 200 of the visited person) by reading a QR code. When the visited person U3 is absent, connection between the information processing apparatus 100 and the intercom master unit 20 can be established, but connection with the portable terminal 200 of the visited person U3 cannot be established.

The following methods are conceivable as a decision method of absence of a response from the visited person terminal 210.
(a1) Connection with the intercom master unit 20 can be established, but connection with the portable terminal 200 of the visited person cannot be established (for example, a timeout without a response).
(a2) Visitor information is transmitted to the visited person terminal 210 (at least any one of the intercom master unit 20 and the portable terminal 200 of the visited person), but the intercom master unit 20 receives the visitor information and the visitor information cannot be transmitted to the portable terminal 200 of the visited person (for example, a timeout without a response).
(a3) Connection with the portable terminal 200 of the visited person is established, and transmission of visitor information is normally completed, but there is no reply from the portable terminal 200 of the visited person (for example, a timeout without a response).

Information transmitted from the visitor terminal 100 to the authentication service server 5 further includes, as information about a visit destination, for example, identification information about the portable terminal 200 of the visited person U3 included in connection information, in addition to visitor information transmitted to the information processing apparatus 210.

The authentication service server 5 stores the visitor information received from the visitor terminal 100, the identification information about the portable terminal 200 of the visited person U3 being a visit destination, and reception date and time information in association with one another. The authentication service server 5 accumulates the received visitor information as visitor history information of the portable terminal 200 of the visited person U3 for each portable terminal 200 of the visited person U3. The authentication service server 5 transmits the visitor history information of the portable terminal 200 of the visited person U3 to the portable terminal 200 of the visited person U3 in response to an inquiry from the portable terminal 200 of the visited person U3. Alternatively, a message notifying that there is a visitor may be transmitted to the portable terminal 200 of the visited person U3. The authentication service server 5 may provide a user-specific Web page for each account of the portable terminal 200 of the visited person U3, and the visitor history information may be able to be viewed by logging into the special Web page.

A visitor information acquisition unit 220 of the information processing apparatus (visited person terminal) 200 is connected to the authentication service server 5 via the communication network 2 such as a cellular phone communication network, and acquires the visitor history information associated with the identification information about the portable terminal 200 of the visited person U3. A display processing unit 222 displays, on a display 202, a visit history screen 410 that displays the acquired visitor history information. The visitor history information displayed on the visit history screen 410 includes, for example, a visit date and time, belonging of a visitor, a name, a face image, and the like.

When the information processing apparatus 210 is the intercom master unit 20, the visited person U3 may be able to display the visit history screen 410 on the display processing unit 222 and confirm the visitor history information after returning home.

### Operation Example

An operation of the information processing apparatus 210 will be described by using FIG. 11. In FIG. 11, the information processing apparatus 210 is described with the portable terminal 200 of the visited person U3 as an example. However, the information processing apparatus 210 may be the intercom master unit 20, and is at least one of the portable terminal 200 of the visited person U3 and the intercom master unit 20.

First, an application of the visitor reception system 1 is activated in advance in the portable terminal 200 of the visited person U3. A visitor U1 installs an application (described as a “door intercom application” in FIG. 11) of the visitor reception system 1 in advance in the portable terminal 100. Then, the visitor U1 performs personal identification by face authentication on the visitor terminal 100 at a time of a visit (step S101), and, when the authentication succeeds, the visitor terminal 100 can be used. Then, the door intercom application is activated by the visitor terminal 100 (step S103).

Then, the visitor U1 captures and reads a QR code 12 installed near a gate 8 of a visited person house by a camera 102 according to a guidance of the visitor terminal 100 (step S105). A QR code reading screen 302 is displayed on the visitor terminal 100. In the visitor terminal 100, a connection information acquisition unit 120 acquires connection information from the QR code 12, and the visitor information transmission unit 122 makes a connection request with the portable terminal 200 of the visited person U3 by using the connection information acquired by the connection information acquisition unit 120 (step S107). At this time, in the visitor terminal 100, a control unit 124 may display a call screen 304.

When the visited person U3 is absent, the portable terminal 200 of the visited person U3 does not respond to the connection request from the visitor terminal 100. Thus, when there is no response for a predetermined period of time or longer in the visitor terminal 100 (step S121), the control unit 124 displays, on a display 104, an absence response screen 308 indicating a possibility of absence of the visited person U3 (step S123).

Furthermore, the visitor information transmission unit 122 transmits visitor information and identification information about the portable terminal 200 of the visited person U3 being a visit destination in association with each other to the authentication service server 5 via the communication network 2 such as a local communication network (step S124).

Then, the visitor information acquisition unit 220 of the portable terminal 200 of the visited person U3 accesses the authentication service server 5 and acquires visitor history information, and the display processing unit 222 displays the visit history screen 410 on the display 202 (step S131). As described above, the authentication service server 5 may notify the portable terminal 200 of the visited person U3 that there is a visitor, and the portable terminal 200 of the visited person U3 may access the authentication service server 5 and acquire (pull-type) the visitor history information, or may transmit (push-type) the visitor history information from the authentication service server 5 to the portable terminal 200 of the visited person U3.

According to the present example embodiment, when there is no response from the visited person terminal 210, the visitor terminal 100 transmits visitor information from the visitor information transmission unit 122 to the authentication service server 5, and thus history information about a visitor can be managed in the authentication service server 5. Then, the visitor information acquisition unit 220 of the portable terminal 200 of the visited person U3 accesses the authentication service server 5 and acquires the history information, and the display processing unit 222 can display the history information on the display 202. In this way, the visited person U3 can confirm the information about the visitor U1 during absence.

### Fifth Example Embodiment

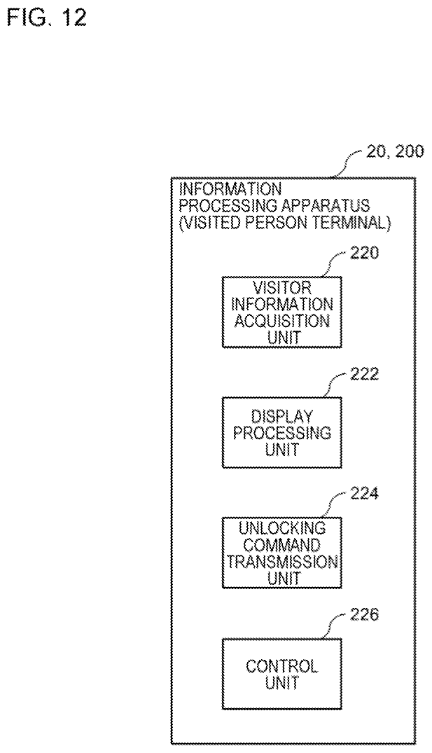

FIG. 12 is a functional block diagram illustrating a functional configuration example of an information processing apparatus 210 (a portable terminal 200 of a visited person or an intercom master unit 20) according to the present example embodiment. The information processing apparatus 210 according to the present example embodiment is the same as the information processing apparatus 210 in FIG. 7 except for a point that the information processing apparatus 210 according to the present example embodiment has a configuration for changing a processing content by visitor. A visitor terminal 100 will be described by using FIG. 10. Note that, the configuration of the present example embodiment can be combined as long as the present example embodiment is not inconsistent with at least any one of configurations of other example embodiments.

The information processing apparatus 210 in FIG. 12 further includes a control unit 226 in addition to the configuration of the information processing apparatus 210 in FIG. 7. The control unit 226 changes a processing content by visitor.

A person being a target for public personal identification among visitors is exemplified below, for example, which is not limited thereto.
(b1) Home-delivery company (delivery of a package, and a package drop (special storage box) of a delivery product such as a box lunch)
(b2) Public worker (an inspection, and meter reading) such as gas, electricity, and water
(b3) Nurse and pharmacist (regular visiting care and delivery of medicine)
(b4) Police and public office-related (such as a check for a resident, and various investigations and checks)

A visitor is classified into, for example, (c1) a person that has already been subjected to the personal identification publicly described above, (c2) an acquaintance including a friend and a relative, and (c3) other outsiders including a person who performs door-to-door sales, a suspicious person, and the like.

The control unit 226 may decide which classification a visitor is put into by at least any one of the following methods.
(d1) (c1) A registered person is determined by using belonging information (for example, a company code and the like) or certificate information included in visitor information. Furthermore, a type of occupation is determined from the belonging information.
(d2) By using identification information (for example, a door intercom application or a digital staff identity card application) about an application installed in the visitor terminal 100, (c1) a registered person is decided in a case of a digital staff identity card, and (c2) an acquaintance is decided in a case of the door intercom application. A person who does not use an application is classified into (c3) an outsider.
(d3) Information about a person having a high visit frequency such as an acquaintance and a home-visitor nurse in charge is registered in advance, and (c1) a registered person or (c2) an acquaintance is decided by performing comparison with a name and a face image of a visitor in visitor information. Furthermore, a home-delivery company in charge of regular delivery is registered in advance, and a person in charge is distinguished.
(d4) When classification cannot be determined by the decision in (d1) to (d3) described above, a person is classified into (c3) an outsider.

Processing contents by visitor by the control unit 226 are exemplified below, which are not limited thereto. The plurality of processing contents below may be combined within a consistent range.
(e1) In a case of (c1) a registered person or (c2) an acquaintance, calling the portable terminal 200 of the visited person or the intercom master unit 20 is permitted.
(e2) In a case of (c3) an outsider, a call is prohibited, absence is notified, or a response screen giving an instruction to register a matter (message memo) is displayed on the visitor terminal 100.
(e3) When a home-delivery company is distinguished, a response screen in which at least any one of taking back a package, a package drop, and registration of a message memo can be selected is displayed on the visitor terminal 100.
(e4) When a person in charge of regular delivery in a home-delivery company is distinguished in
(e3), an instruction for a package drop (into a special storage box) is automatically responded.

### Operation Example 1

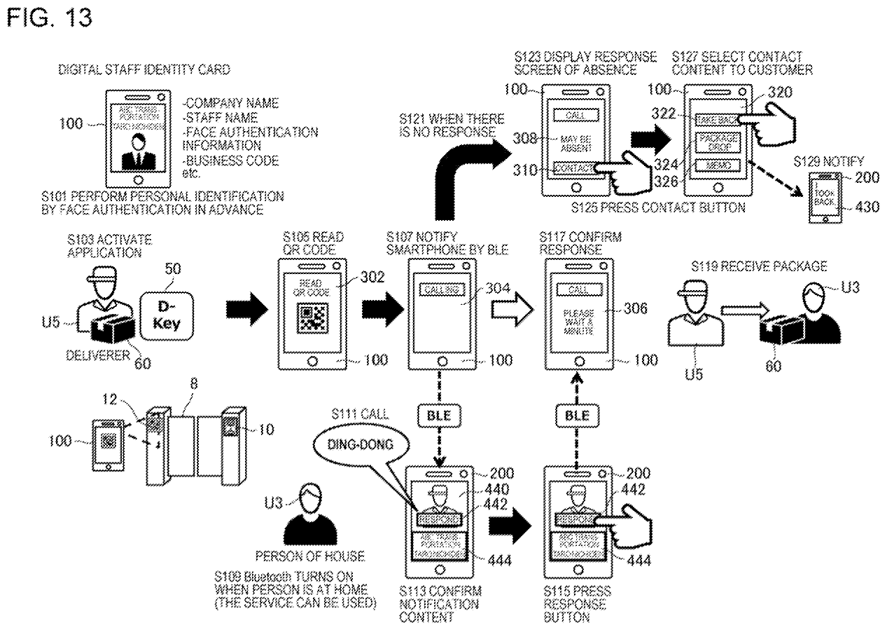

FIG. 13 is a diagram illustrating a first usage example of a visitor reception system 1 according to the present example embodiment. In this example, an operation example when a visitor U5 is a home-delivery company is illustrated. The visitor terminal 100 will be described by using FIG. 10. The information processing apparatus 210 will be described by using FIG. 12. In FIG. 13, the information processing apparatus 210 is described with the portable terminal 200 of a visited person U3 as an example. However, the information processing apparatus 210 may be an intercom master unit 20, and is at least one of the portable terminal 200 of the visited person U3 and the intercom master unit 20. Note that, the configuration of the present example embodiment can be combined as long as the present example embodiment is not inconsistent with at least any one of configurations of other example embodiments.

First, an application of the visitor reception system 1 is activated in advance in the portable terminal 200 of the visited person U3. The visitor U5 who is a home-delivery company installs an application (described as a “digital staff identity card” in FIG. 13) of the visitor reception system 1 in advance in the portable terminal 100. Then, the visitor U5 performs personal identification by face authentication on the visitor terminal 100 at a time of a visit (step S101), and, when the authentication succeeds, the visitor terminal 100 can be used. In the digital staff identity card application, as visitor information (indicated as a digital key 50 in FIG. 13), for example, information such as a company name, a staff name, a face image (face authentication information), and a business code of a user of the visitor terminal 100 who succeeds in authentication is stored. Herein, a business code in the visitor information about the visitor U5 indicates a home-delivery company.

Then, the digital staff identity card application is activated by the visitor terminal 100 (step S103). Then, the visitor U5 captures and reads a QR code 12 installed near a gate 8 of a visited person house by a camera 102 according to a guidance of the visitor terminal 100 (step S105). A QR code reading screen 302 is displayed on the visitor terminal 100. In the visitor terminal 100, a connection information acquisition unit 120 acquires connection information from the QR code 12, and a visitor information transmission unit 122 makes a connection request with the portable terminal 200 of the visited person U3 by using the connection information acquired by the connection information acquisition unit 120 (step S107). At this time, in the visitor terminal 100, a control unit 124 may display a call screen 304.

Then, when the visited person U3 who is a recipient of a package 60 is at home, and communication between the visitor terminal 100 and the portable terminal 200 of the visited person U3 is established (step S109), the visitor terminal 100 transmits visitor information to the portable terminal 200 of the visited person U3. Herein, the portable terminal 200 of the visited person U3 determines the visitor, based on the visitor information received by the control unit 226.

Then, when the visitor U5 is determined as a home-delivery company, based on the business code and the like, the control unit 226 permits an output (an output of a call sound and a display of a call screen 440) for calling the visited person U3. Then, a display processing unit 222 displays the call screen 440 on a display 202 (step S111). The call screen 440 displays at least a face picture of the visitor U5 included in the visitor information received from the visitor terminal 100. Furthermore, the call screen 440 may include a response button 442 for the visited person U3 to respond, and a visitor information display portion 444 that displays information, such as belonging and a name of the visitor U5, included in the visitor information.

When the visited person U3 confirms a notification content of the call screen 440 (step S113), and presses the response button 442 (step S115), a response notification is transmitted from the portable terminal 200 of the visited person U3 to the visitor terminal 100. In the visitor terminal 100, the control unit 124 displays, on a display 104, a home response screen 306 indicating a content of the response notification received from the portable terminal 200 of the visited person U3. The visitor U1 can confirm the response content (step S117). A content of the response notification may include a content indicating that the visited person U3 is at home, such as “Please wait a minute.”, for example. Alternatively, the content may include a content indicating that the visited person U3 is at home but cannot deal, such as “I am not available since I am currently busy.”. Then, the visited person U3 goes to an entrance, and receives the package 60 from the visitor U5 (step S119).

On the other hand, when the visited person U3 is absent, the portable terminal 200 of the visited person U3 does not respond to the connection request from the visitor terminal 100. Thus, when there is no response for a predetermined period of time or longer in the visitor terminal 100 (step S121), the control unit 124 displays, on a display 104, an absence response screen 308 indicating a possibility of absence of the visited person U3 (step S123).

The absent response screen 308 may display a message notifying absence and also include a contact button 310. When pressing of the contact button 310 is received, the control unit 124 displays a contact content selection screen 320 on the display 104 (step S127). The contact content selection screen 320 includes a take back button 322, a package drop button 324, and a memo button 326. When the take back button 322 is pressed, the visitor terminal 100 receives a fact that the package 60 is taken back as a content for contact. When the package drop button 324 is pressed, a fact that the package 60 is placed at a predetermined placement place is received as a content for contact. When the memo button 326 is pressed, the control unit 124 further displays a screen (not illustrated) that receives an input of a message content to the visited person U3, and receives an operation input of text or a sound input of the visitor U5.

Then, the visitor information transmission unit 122 transmits, to the portable terminal 200 of the visited person U3, the contact content to the visited person U3 being received on the contact content selection screen 320 (step S129). When the portable terminal 200 of the visited person U3 receives the contact content transmitted from the visitor terminal 100, the display processing unit 222 displays a notification screen 430. In this example, a message indicating that the package 60 is taken back is displayed on the notification screen 430. When a package drop is selected, a message indicating that the package 60 is placed at a predetermined placement place is displayed. When a message memo is recorded, a message recorded in the message memo is displayed on the notification screen 460.

Note that, a contact content may be directly transmitted from the visitor terminal 100 to the portable terminal 200 of the visited person U3, or, as described in the fourth example embodiment, a contact content from the visitor U5 may be transmitted to the authentication service server 5, and the portable terminal 200 of the visited person U3 may access the authentication service server 5 and receive the contact content.

### Operation Example 2

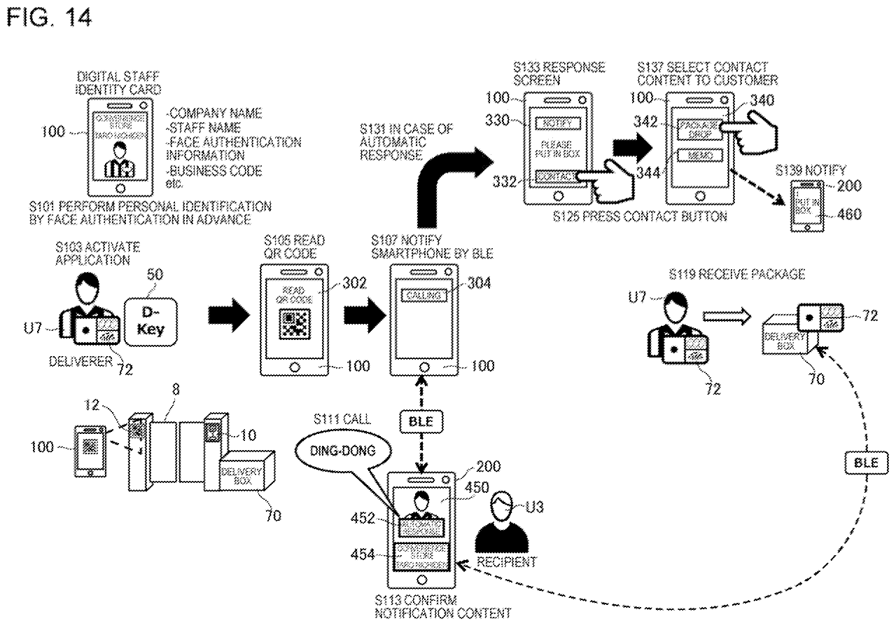

FIG. 14 is a diagram illustrating a second usage example of the visitor reception system 1 according to the present example embodiment. In this example, an operation example when a visitor U7 is a deliverer of a product of a convenience store is illustrated. The visitor terminal 100 will be described by using FIG. 10. The information processing apparatus 210 will be described by using FIG. 12. In FIG. 14, the information processing apparatus 210 is described with the portable terminal 200 of the visited person U3 as an example. However, the information processing apparatus 210 may be the intercom master unit 20, and is at least one of the portable terminal 200 of the visited person U3 and the intercom master unit 20. Note that, the configuration of the present example embodiment can be combined as long as the present example embodiment is not inconsistent with at least any one of configurations of other example embodiments.

First, an application of the visitor reception system 1 is activated in advance in the portable terminal 200 of the visited person U3. The visitor U7 who is a deliverer of a product of a convenience store installs an application (described as a “digital staff identity card” in FIG. 14) of the visitor reception system 1 in advance in the portable terminal 100. Then, the visitor U7 performs personal identification by face authentication on the visitor terminal 100 at a time of a visit (step S101), and, when the authentication succeeds, the visitor terminal 100 can be used. In the digital staff identity card application, as visitor information (indicated as the digital key 50 in FIG. 14), for example, information such as a company name, a staff name, a face image (face authentication information), and a business code of a user of the visitor terminal 100 who succeeds in authentication is stored. Herein, a business code in the visitor information about the visitor U7 indicates a deliverer of a convenience store.

Then, the digital staff identity card application is activated by the visitor terminal 100 (step S103). Then, the visitor U5 captures and reads the QR code 12 installed near the gate 8 of the visited person house by the camera 102 according to a guidance of the visitor terminal 100 (step S105). The QR code reading screen 302 is displayed on the visitor terminal 100. In the visitor terminal 100, the connection information acquisition unit 120 acquires connection information from the QR code 12, and the visitor information transmission unit 122 makes a connection request with the portable terminal 200 of the visited person U3 by using the connection information acquired by the connection information acquisition unit 120 (step S107). At this time, in the visitor terminal 100, the control unit 124 may display the call screen 304.

Then, when the visited person U3 who is a recipient of a product 72 is at home, communication between the visitor terminal 100 and the portable terminal 200 of the visited person U3 is established, and the visitor terminal 100 then transmits visitor information to the portable terminal 200 of the visited person U3. Herein, the portable terminal 200 of the visited person U3 determines the visitor, based on the visitor information received by the control unit 226.

Then, when the visitor U7 is determined as a deliverer of a convenience store, based on the business code and the like, the control unit 226 permits an output (an output of a call sound and a display of the call screen 450) for calling the visited person U3, and also causes the display processing unit 222 to perform an automatic response notification. The display processing unit 222 displays the call screen 450 on the display 202 (step S111). The call screen 450 displays fewer face pictures of the visitor U7 included in the visitor information received from the visitor terminal 100. Furthermore, the call screen 450 may include the visitor information display portion 454 that displays information, such as belonging and a name of the visitor U7, included in the received visitor information.

The visitor U3 confirms the notification content of the call screen 450 (step S113). Meanwhile, the control unit 226 notifies the visitor terminal 100 of an automatic response. When the notification of the automatic response is received (step S131), the control unit 124 displays an automatic response screen 330 in the visitor terminal 100 (step S133).

The automatic response screen 330 may display a message instructing the product 72 to be put into a delivery box 70, and also include a contact button 332. When pressing of the contact button 332 is received, the control unit 124 displays a contact content selection screen 340 on the display 104 (step S137). The contact content selection screen 340 includes a package drop button 342 and a memo button 344. When the package drop button 342 is pressed, a fact that the product 72 is put in the delivery box 70 is received as a content for contact. When the memo button 344 is pressed, the control unit 124 further displays a screen (not illustrated) that receives an input of a message content to the visited person U3, and receives an operation input of text or a sound input of the visitor U5.

Then, the visitor information transmission unit 122 transmits, to the portable terminal 200 of the visited person U3, the contact content to the visited person U3 being received on the contact content selection screen 340 (step S139). When the portable terminal 200 of the visited person U3 receives the contact content transmitted from the visitor terminal 100, the display processing unit 222 displays a notification screen 460. In this example, a message notifying that the product 72 is put in the delivery box 70 is displayed on the notification screen 460. When a message memo is recorded, a message recorded in the message memo is displayed on the notification screen 460.

Note that, a contact content may be directly transmitted from the visitor terminal 100 to the portable terminal 200 of the visited person U3, or, as described in the fourth example embodiment, a contact content from the visitor U5 may be transmitted to the authentication service server 5, and the portable terminal 200 of the visited person U3 may access the authentication service server 5 and receive the contact content.

According to the present example embodiment, the control unit 226 changes a processing content by visitor, and thus appropriate reception can be implemented depending on a visitor. For example, in the operation example 2, when the control unit 226 determines that a visitor U6 is a deliverer of the product 72 of a convenience store, the visited person U3 can instruct the deliverer to put the product 72 into the delivery box 70 without reception by notifying an automatic response to the visitor terminal 100.

### Sixth Example Embodiment

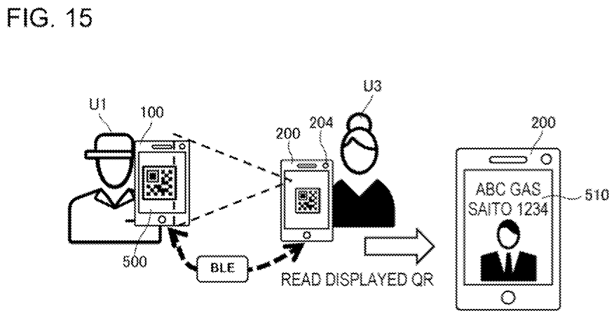

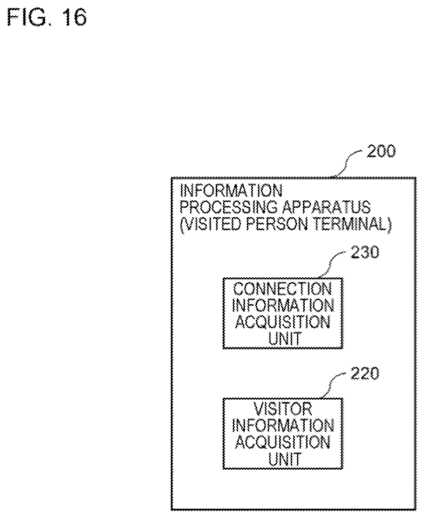

FIG. 15 is a diagram illustrating a usage example of a visitor reception system 1 according to the present example embodiment. The present example embodiment is different from any of the example embodiments described above in a point that the present example embodiment has a configuration being used when a visitor U1 and a visited person U3 meet face-to-face and capable of transmitting visitor information that has already been subjected to personal identification as a digital business card to the visited person U3. FIG. 16 is a functional block diagram illustrating a logical configuration example of an information processing apparatus (visited person terminal) 200 according to the present example embodiment. The information processing apparatus (visited person terminal) 200 will be described by using FIG. 16. A visitor terminal 100 will be described by using FIG. 3. Note that, the configuration of the present example embodiment can be combined as long as the present example embodiment is not inconsistent with at least any one of configurations of other example embodiments.

The information processing apparatus (visited person terminal) 200 includes a connection information acquisition unit 230 and a visitor information acquisition unit 220. The connection information acquisition unit 230 acquires connection information for communicating with the visitor terminal 100 by processing an image captured by a camera 204 included in the portable terminal 200 of the visited person U3. The visitor information acquisition unit 220 requests and acquires visitor information from the visitor terminal 100 by using the acquired connection information. The visitor information acquired by the visitor information acquisition unit 220 may be displayed as a visitor information display screen 510 on a display 202.

According to the present example embodiment, qualification certificate information, infectious disease certificate information, and the like about a visitor can be confirmed in the portable terminal 200 of the visited person U3. Further, visitor information received by the portable terminal 200 of the visited person U3 can also be used for verification of validity of a visitor later. Further, when a digital staff identity card 40 provided with a digital signature and the like are received as in an example embodiment described below, validity of the digital staff identity card 40 can be confirmed by verifying the digital signature at a time of the reception.

### Seventh Example Embodiment

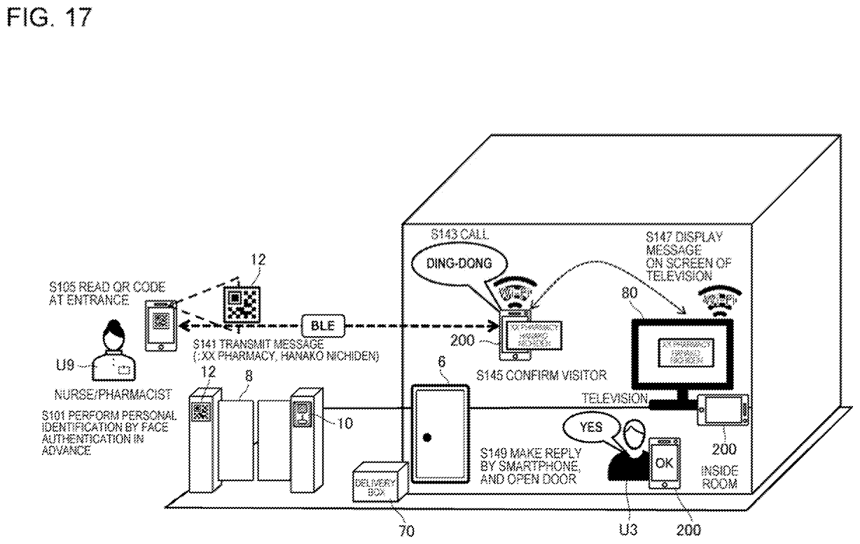

FIG. 17 is a diagram illustrating a usage example of a visitor reception system 1 according to the present example embodiment. The present example embodiment is the same as the first to fifth example embodiments described above except for a point that the present example embodiment has a configuration capable of dealing even when, for example, an old person or the like is disabled in hearing and cannot deal without noticing a visit of a visitor. Note that, the configuration of the present example embodiment can be combined as long as the present example embodiment is not inconsistent with at least any one of configurations of other example embodiments.

In this example, the visitor reception system 1 further includes a television 80. A visited person U3 is assumed to often watch the television 80 at home. Thus, in the present example embodiment, when a visit of a visitor is detected in a portable terminal 200 of the visited person U3, a message notifying the visit is displayed on the television 80 from the portable terminal 200 of the visited person U3.

### Operation Example

In the present example embodiment, for example, a case where a visitor U9 who has already been registered in advance, such as a pharmacist, and has already been subjected to personal identification visits will be described as an example. First, an application of the visitor reception system 1 is activated in advance in the portable terminal 200 of the visited person U3. The visitor U9 who is a pharmacist installs the application of the visitor reception system 1 in advance in a portable terminal 100. Then, the visitor U7 performs personal identification by face authentication on the visitor terminal 100 at a time of a visit (step S101), and, when the authentication succeeds, the visitor terminal 100 can be used. For example, information such as a pharmacy name to which the pharmacist being the user of the visitor terminal 100 who succeeds in the authentication belongs, a pharmacist name, a face image (face authentication information), and a business code is stored. Herein, a business code in visitor information about the visitor U9 indicates a pharmacist.

Then, after the application is activated in the visitor terminal 100, the visitor U5 captures and reads a QR code 12 installed near a gate 8 of a visited person house by a camera 102 according to a guidance of the visitor terminal 100 (step S105). In the visitor terminal 100, a connection information acquisition unit 120 acquires connection information from the QR code 12, and a visitor information transmission unit 122 makes a connection request with the portable terminal 200 of the visited person U3 by using the connection information acquired by the connection information acquisition unit 120.

After communication between the visitor terminal 100 and the portable terminal 200 of the visited person U3 is established, the visitor terminal 100 transmits the visitor information to the portable terminal 200 of the visited person U3 (step S141). Herein, the portable terminal 200 of the visited person U3 determines the visitor, based on the visitor information received by a control unit 226.

Then, when the visitor U9 is determined as a pharmacist, based on the business code and the like (step S145), the control unit 226 permits an output for calling the visited person U3. Then, the control unit 226 causes a display processing unit 222 to display a message on a screen of the television 80 (step S147). The screen displays, together with a message notifying a visit of a visitor, at least belonging and a name of the visitor U9 included in the visitor information received from the visitor terminal 100. Furthermore, a face image of the visitor U9 may be displayed on the television 80.

The portable terminal 200 of the visited person U3 and the television 80 may be connected by, for example, a wireless local area network (LAN) in a house (so-called wireless fidelity (Wi-Fi). The visited person U3 can confirm the information about the visitor being displayed on the screen of the television 80, and deal with the visitor by using the portable terminal 200 of the visited person U3 (step S149). The visited person U3 may speak to the visitor U9 by using the portable terminal 200 of the visited person U3. For example, the visited person U3 may request the visitor U9 to put medicine into a delivery box 70, or may open a door 6 and deal with the visited person U9.

According to the present example embodiment, even a visited person who hardly notices a notification by the portable terminal 200 of the visited person U3 is made more likely to notice presence of a visitor since a function of notifying a visit is provided to the television 80 and the like. Even a person who does not carry the portable terminal 200 of the visited person U3 such as an old person can be encouraged to use the present visitor reception system 1.

### Eighth Example Embodiment

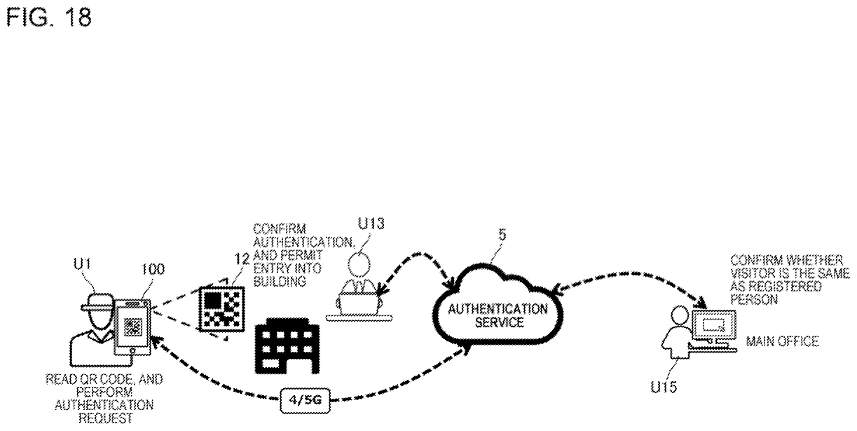

FIG. 18 is a diagram illustrating a usage example of a visitor reception system 1 according to the present example embodiment. The present example embodiment is similar to any of the example embodiments described above except for a point that the present example embodiment has a configuration for authenticating visitor information transmitted from a visitor terminal 100 in an authentication service server 5 when the visitor terminal 100 reads a QR code 12. For example, in this example, an unlocking command transmission unit 224 of an information processing apparatus 210 controls permission of unlocking when a visitor U1 enters a building and the like instead of an individual house.

In the visitor reception system 1, a connection information acquisition unit 120 of the visitor terminal 100 acquires connection information by reading the QR code 12 provided on a building. Then, the visitor information transmission unit 122 is connected to the authentication service server 5 via a communication network 2 such as a cellular phone communication network by using the connection information, and transmits visitor information. The authentication service server 5 performs authentication processing on the visitor information received from the visitor terminal 100. For example, the visitor U1 installs an application, and then registers authentication information as personal identification information in advance in the authentication service server 5. Then, the authentication service server 5 compares the received visitor information with the registered authentication information, and decides whether the visitor is a registered visitor.

When the authentication succeeds, the authentication service server 5 notifies the information processing apparatus 210 of a manager U13 of the building of the authentication success via the communication network 2. Then, a display control unit 222 of the information processing apparatus 210 displays the authentication success, the manager U13 performs an operation of permitting an entry of the visitor U1 into the building, and the unlocking command transmission unit 224 transmits an unlocking command to a door 6 of the building.

When the authentication fails, the authentication service server 5 notifies the information processing apparatus 210 of the manager U13 of the building of the authentication failure via the communication network 2. Then, the display control unit 222 of the information processing apparatus 210 displays the authentication failure, and the manager U13 may inform the visitor U1 that an entry of the visitor U1 into the building is not permitted via an intercom slave unit 10 or the like.

Furthermore, the authentication service server 5 may provide the visitor information received from the visitor U1 to, for example, a main office of an entrepreneur to which the visitor U1 belongs. The manager U15 of the main office of the entrepreneur can confirm the visitor information. In this way, for example, the manager U15 of the main office of the entrepreneur can confirm that unauthorized behavior such as spoofing is not performed by the visitor U1.

According to the present example embodiment, also at a time of an entry into a building and the like, the visitor terminal 100 can request the authentication service server 5 to perform authentication of the visitor U1. Further, an authentication result is also provided to a manager of an entrepreneur to which the visitor U1 belongs, and thus the manager can also confirm that unauthorized behavior such as spoofing is not performed by the visitor.

### Ninth Example Embodiment

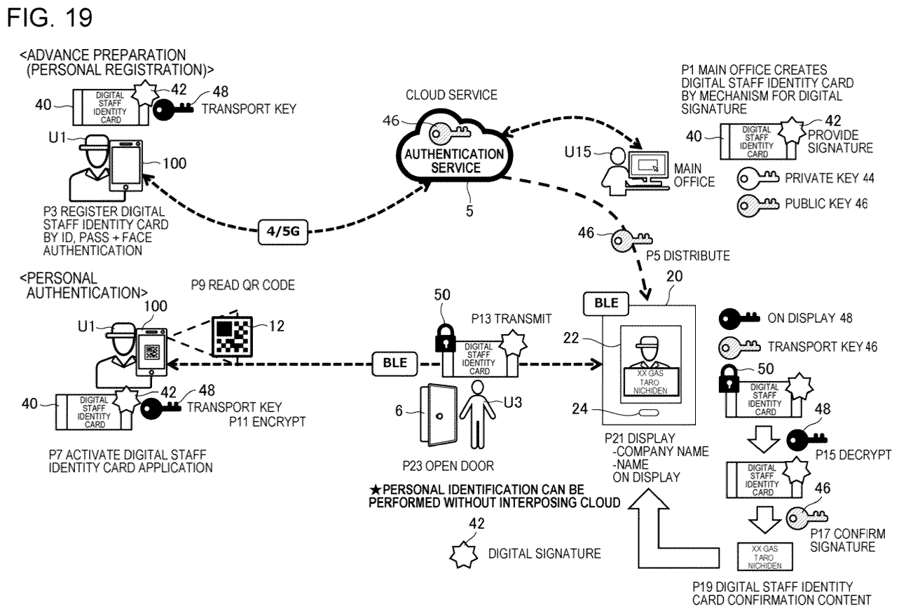

FIG. 19 is a diagram illustrating an example of a procedure of personal registration and personal identification.

First, at a main office of an entrepreneur to which a visitor U1 belongs, for example, a manager U15 requests an authentication service server 5 to create a digital staff identity card 40 using a mechanism for a digital signature (procedure P1). The digital staff identity card 40 is provided with a digital signatures 42 encrypted by using a private key 44. The authentication service server 5 distributes the digital staff identity card 40 and a transport key 48 to a visitor terminal 100, and distributes a public key 46 to an intercom master unit 20 (procedure P5).

For example, the digital signature 42 may be set for each individual such as a police officer, or may be set for each company by the authentication service server 5 executing for a general company and the like.

The visitor U1 logs into the visitor reception system 1 by using the visitor terminal 100 by face authentication and inputting a user ID and a password, and registers the digital staff identity card 40 distributed from the authentication service server 5 in the visitor terminal 100 (procedure P3). The procedure up to this point completes advance preparation.

Then, at a time of a visit, the visitor U1 activates a digital staff identity card application of the digital staff identity card 40 by the visitor terminal 100 (procedure P7). Note that, use of the visitor terminal 100 can be permitted by performing personal identification by face authentication, and the application can be activated (or the visitor reception system 1 can be logged in).

Then, a QR code 12 is read by using a camera 102 of the visitor terminal 100 by the application (procedure P9), and a connection information acquisition unit 120 acquires connection information. Then, when communication with the intercom master unit 20 is performed and connection succeeds, the digital staff identity card 40 is encrypted by using the transport key 48 (provided with a digital key 50) (procedure P11), and the visitor information transmission unit 122 transmits the digital staff identity card 40 to the intercom master unit 20 (procedure P13).

Then, the intercom master unit 20 decrypts the received digital staff identity card 40 by using the transport key 48 (procedure P15), and further decrypts the digital signature 42 by using the public key 46 (procedure P17). Then, after validity of the digital staff identity card 40 is confirmed (procedure P19), visitor information about a company name, a name, and the like of the visitor U1 being recorded in the digital staff identity card 40 is displayed on a display 22 (procedure P21).

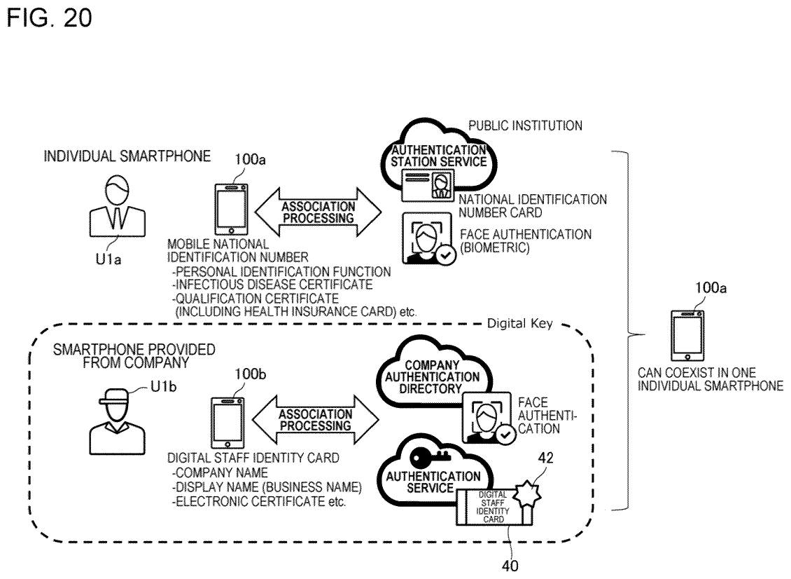

FIG. 20 is a diagram illustrating visitor information registered in the visitor terminal 100. The visitor information registered in the visitor information 100 varies in a case of a smartphone 100a possessed by an individual user U1a and a case of a smartphone 100b being provided from a company and used.

For example, in the case of the individual smartphone 100a, for example, biometric authentication information is registered by eKYC and the like, personal authentication is also performed in a public institution such as a public office, based on a national identification number card and the like, and digital information about the national identification number card is registered in the smartphone 100a (mobile national identification number).

The mobile national identification number may include a personal identification function, infectious disease certificate information, qualification certification information (for example, information about a health insurance card), and the like.

On the other hand, for the smartphone 100b provided from the company, the authentication service server 5 registers, in the smartphone 100b, face authentication information managed by a directory for each company to which a user U1b belongs, and the digital staff identity card 40 provided with the digital signature 42 authenticated by the authentication service server 5.

A company name to which the user U1b belongs, and a name (for example, a business name) are stored as the visitor information in the digital staff identity card 40.

Note that, a function of the digital staff identity card 40 may be put together in the individual smartphone 100a.

According to the present example embodiment, visitor information subjected to appropriate authentication processing can be stored in the visitor terminal 100.

While the example embodiments of the present invention have been described with reference to the drawings, the example embodiments are only exemplification of the present invention, and various configurations other than the above-described example embodiments can also be employed.

For example, the QR code 12 may have, for example, a seal shape, and may be sold at least one by one in combination with an application of the portable terminal 200 of the visited person U3 of the visitor reception system 1 or alone. Alternatively, an image of the QR code 12 may be able to be downloaded from a predetermined Web site, printed, and attached.

Information recorded in a QR code is encrypted in such a way as to be decrypted by an application of the portable terminal 200 of the visited person. For example, a scratch card in which an activation code (for example, a code formed of a combination of a predetermined number of digits of letters and numbers) is hidden is sold together with a QR code. An application is downloaded, installed, and activated in the portable terminal 200 of the visited person. In initial setting of the application, a reading screen of the QR code is displayed on the portable terminal 200 of the visited person. The visited person reads the QR code according to a guidance of the screen. At this time, a screen that prompts an input of the activation code described on the scratch card is displayed on the portable terminal 200 of the visited person. The visited person peels a coating of the scratch card, acquires the activation code, and inputs the activation code. The portable terminal 200 of the visited person can decrypt the QR code by receiving the input of the activation code, and can acquire identification information for connection with Bluetooth of the portable terminal 200 of the visited person being recorded in the QR code.

The portable terminal 200 of the visited person stores identification information about himself/herself in the memory 1030, for example. The visited person attaches a sticker of a QR code to the intercom slave unit 10.

Meanwhile, decoding information (processing logic) for decrypting a QR code common to the present visitor reception system 1 is included in the application of the visitor terminal 100, and stored in the memory 1030 of the visitor terminal 100. When the QR code is read, the visitor terminal 100 performs decryption by using the decoding information, and acquires identification information for connection with Bluetooth of the portable terminal 200 of the visited person being recorded in the QR code. Then, a connection request including the identification information for connection with Bluetooth of the portable terminal 200 of the visited person is transmitted toward the portable terminal 200 of the visited person.

When the portable terminal 200 of the visited person receives the connection request transmitted from the visitor terminal 100, the portable terminal 200 confirms the identification information for connection with Bluetooth included in the connection request, confirms that the identification information for connection with Bluetooth of the portable terminal 200 of the visited person is included, and then responds to the connection request. In this way, connection between the visitor terminal 100 and the portable terminal 200 of the visited person is established.

Furthermore, in another example, when a display (not illustrated) is provided in the intercom slave unit 10 and the like, an image of the QR code 12 may be transmitted from the portable terminal 200 of the visited person U3 to the slave unit 10, and stored in the memory 1030 of the slave unit 10, and, when a visitor is detected (for example, when pressing of the call button 14 is detected, and the like), the QR code may be displayed on the display of the slave unit 10.

The invention of the present application is described above with reference to the example embodiments and the examples, but the invention of the present application is not limited to the example embodiments and the examples described above. Various modifications that can be understood by those skilled in the art can be made to the configuration and the details of the invention of the present application within the scope of the invention of the present application.

Note that, when information about a user (a visitor and a visited person) is acquired and used in the present invention, this is lawfully performed.

A part or the whole of the above-described example embodiment may also be described in supplementary notes below, which is not limited thereto.
1. A program executed by a computer constituting a visitor terminal held by a visitor, the program causing a computer to implement:
   an acquisition unit that acquires connection information for communicating with a visited person terminal by processing an image captured by a capturing unit included in the visitor terminal or communicating with a communication apparatus installed in a visited person house; and
   a transmission unit that transmits visitor information being stored in advance to the visited person terminal by using the acquired connection information.
2. The program according to supplementary note 1, wherein
   the connection information for communicating with the visited person terminal is information for short-range wireless communication.
3. The program according to supplementary note 1 or 2, wherein
   the image includes at least code information indicating the connection information.
4. The program according to any one of supplementary notes 1 to 3, wherein
   the visitor information includes an image of the visitor.
5. The program according to any one of supplementary notes 1 to 4, wherein
   the visitor information includes certificate information about the visitor.
6. The program according to any one of supplementary notes 1 to 5, wherein
   the visitor information includes belonging information about the visitor.
7. The program according to supplementary note 6, further causing a computer to implement
   a control unit that changes display information or a processing content, according to belonging indicated by the belonging information about the visitor.
8. A program executed by a computer constituting a visited person terminal held by a visited person, the program causing a computer to implement:
   an acquisition unit that acquires visitor information from a visitor terminal held by a visitor;
   a display processing unit that displays an image including the acquired visitor information on a screen; and
   a transmission unit that transmits an unlocking command to an entranceway when an unlocking command of the entranceway is input after the image is displayed by the display processing unit.
9. The program according to supplementary note 8, wherein
   the visitor information includes an image, and
   the display processing unit displays the image and an image of a camera installed in an intercom on an identical screen.
10. The program according to supplementary note 8 or 9, wherein
   the acquisition unit further acquires attribute information about the visitor as the visitor information, and
   the display processing unit displays the acquired attribute information about the visitor on the screen.
11. The program according to any one of supplementary notes 8 to 10, further causing to implement
   a control unit that changes a processing content by the visitor.
12. A program executed by a computer constituting a visited person terminal held by a visited person, the program causing a computer to implement:
   a first acquisition unit that acquires connection information for communicating with a visitor terminal by processing an image captured by a capturing unit included in the visited person terminal; and
   a second acquisition unit that requests and acquires visitor information from the visitor terminal by using the acquired connection information.
13. An information processing apparatus that implements a visitor terminal held by a visitor, the information processing apparatus including:
   an acquisition unit that acquires connection information for communicating with a visited person terminal by processing an image captured by a capturing unit included in the visitor terminal or communicating with a communication apparatus installed in a visited person house; and
   a transmission unit that transmits visitor information being stored in advance to the visited person terminal by using the acquired connection information.
14. The information processing apparatus according to supplementary note 13, wherein
   the connection information for communicating with the visited person terminal is information for short-range wireless communication.
15. The information processing apparatus according to supplementary note 13 or 14, wherein
   the image includes at least code information indicating the connection information.
16. The information processing apparatus according to any one of supplementary notes 13 to 15, wherein
   the visitor information includes an image of the visitor.
17. The information processing apparatus according to any one of supplementary notes 13 to 16, wherein
   the visitor information includes certificate information about the visitor.
18. The information processing apparatus according to any one of supplementary notes 13 to 17, wherein
   the visitor information includes belonging information about the visitor.
19. The information processing apparatus according to supplementary note 18, further including
   a control unit that changes display information or a processing content, according to belonging indicated by the belonging information about the visitor.
20. An information processing apparatus that implements a visited person terminal held by a visited person, the information processing apparatus including:
   an acquisition unit that acquires visitor information from a visitor terminal held by a visitor;
   a display processing unit that displays an image including the acquired visitor information on a screen; and
   a transmission unit that transmits an unlocking command to an entranceway when an unlocking command of the entranceway is input after the image is displayed by the display processing unit.
21. The information processing apparatus according to supplementary note 20, wherein
   the visitor information includes an image, and
   the display processing unit displays the image and an image of a camera installed in an intercom on an identical screen.
22. The information processing apparatus according to supplementary note 20 or 21, wherein
   the acquisition unit further acquires attribute information about the visitor as the visitor information, and
   the display processing unit displays the acquired attribute information about the visitor on the screen.
23. The information processing apparatus according to any one of supplementary notes 20 to 22, further implementing
   a control unit that changes a processing content by the visitor.
24. An information processing apparatus that implements a visited person terminal held by a visited person, the information processing apparatus including:
   a first acquisition unit that acquires connection information for communicating with a visitor terminal by processing an image captured by a capturing unit included in the visited person terminal; and
   a second acquisition unit that requests and acquires visitor information from the visitor terminal by using the acquired connection information.
25. An information processing method of an information processing apparatus that implements a visitor terminal held by a visitor, the information processing method including,
   by the information processing apparatus:
   acquiring connection information for communicating with a visited person terminal by processing an image captured by a capturing unit included in the visitor terminal or communicating with a communication apparatus installed in a visited person house; and
   transmitting visitor information being stored in advance to the visited person terminal by using the acquired connection information.
26. The information processing method according to supplementary note 25, wherein the connection information for communicating with the visited person terminal is information for short-range wireless communication.
27. The information processing method according to supplementary note 25 or 26, wherein
   the image includes at least code information indicating the connection information.
28. The information processing method according to any one of supplementary notes 25 to 27, wherein
   the visitor information includes an image of the visitor.
29. The information processing method according to any one of supplementary notes 25 to 28, wherein
   the visitor information includes certificate information about the visitor.
30. The information processing method according to any one of supplementary notes 25 to 29, wherein
   the visitor information includes belonging information about the visitor.
31. The information processing method according to supplementary note 30, further including,
   by the information processing apparatus,
   changing display information or a processing content, according to belonging indicated by the belonging information about the visitor.
32. An information processing method of an information processing apparatus that implements a visited person terminal held by a visited person, the information processing method including,
   by the information processing apparatus:
   acquiring visitor information from a visitor terminal held by a visitor;
   displaying an image including the acquired visitor information on a screen; and
   transmitting an unlocking command to an entranceway when an unlocking command of the entranceway is input after the image is displayed.
33. The information processing method according to supplementary note 32, wherein
   the visitor information includes an image,
   the information processing method further including,
   by the information processing apparatus,
   displaying the image and an image of a camera installed in an intercom on an identical screen.
34. The information processing method according to supplementary note 32 or 33, further including,
   by the information processing apparatus:
   further acquiring attribute information about the visitor as the visitor information; and
   displaying the acquired attribute information about the visitor on the screen.
35. The information processing method according to any one of supplementary notes 32 to 34, further including,
   by the information processing apparatus,
   changing a processing content by the visitor.
36. An information processing method of an information processing apparatus that implements a visited person terminal held by a visited person, the information processing method including,
   by the information processing apparatus:
   acquiring connection information for communicating with a visitor terminal by processing an image captured by a capturing unit included in the visited person terminal; and
   requesting and acquiring visitor information from the visitor terminal by using the acquired connection information.
37. A visitor reception system including:
   a first information processing apparatus that implements a visitor terminal held by a visitor according to any one of supplementary notes 13 to 19; and
   a second information processing apparatus that implements a visited person terminal held by a visited person according to any one of supplementary notes 20 to 24.

### REFERENCE SIGNS LIST

1 Visitor reception system
2 Communication network
5 Authentication service server
10 Intercom slave unit
12 QR code
14 Call button
16 Camera
20 Intercom master unit
22 Display
24 Conversation button
30 Staff identity card
40 Digital staff identity card
80 Television
100 Visitor terminal (information processing apparatus)
102 Camera
104 Display
120 Connection information acquisition unit
122 Visitor information transmission unit
124 Control unit
200 Portable terminal of visited person
210 Visited person terminal (information processing apparatus)
202 Display
204 Camera
220 Visitor information acquisition unit
222 Display processing unit
224 Unlocking command transmission unit
226 Control unit
230 Connection information acquisition unit
1000 Computer
1010 Bus
1020 Processor
1030 Memory
1040 Storage device
1050 Input/output interface
1060 Network interface

What is claimed is:

1-7. (canceled)

8. A non-transitory computer-readable storage medium storing a program executed by a computer constituting a visited person terminal held by a visited person, the program causing the computer to execute:
a process for acquiring visitor information from a visitor terminal held by a visitor;
a process for displaying an image including the acquired visitor information on a screen; and
a process for an unlocking command to an entranceway when an unlocking command of the entranceway is input after the image is displayed by the process for displaying.

9. The non-transitory computer-readable storage medium according to claim 8, wherein
the visitor information includes an image of the visitor, and
the program further causes the computer to execute
a process for displaying the image of the visitor and an image captured by a camera installed in an intercom on an identical screen.

10. The non-transitory computer-readable storage medium according to claim 8, wherein the program further causes the computer to execute:
a process for further acquiring attribute information about the visitor as the visitor information; and
a process for displaying the acquired attribute information about the visitor on the screen.

11. The non-transitory computer-readable storage medium according to claim 8, wherein the program further causes the computer to execute
a process for changing a processing content by the visitor.

12-19. (canceled)

20. An information processing apparatus that implements a visited person terminal held by a visited person, the information processing apparatus comprising:
at least one memory configured to store instructions; and
at least one processor configured to execute the instructions to:
acquire visitor information from a visitor terminal held by a visitor;
display an image including the acquired visitor information on a screen; and
transmit an unlocking command to an entranceway when an unlocking command of the entranceway is input after the image is displayed.

21. The information processing apparatus according to claim 20, wherein
the visitor information includes an image, and
the at least one processor is further configured to execute the instructions to display the image and an image of a camera installed in an intercom on an identical screen.

22. The information processing apparatus according to claim 20, wherein
the at least one processor is further configured to execute the instructions to:
further acquire attribute information about the visitor as the visitor information, and
display the acquired attribute information about the visitor on the screen.

23. The information processing apparatus according to claim 20, wherein
the at least one processor is further configured to execute the instructions to change a processing content by the visitor.

24-31. (canceled)

32. An information processing method of an information processing apparatus that implements a visited person terminal held by a visited person, the information processing method comprising,
by the information processing apparatus:
acquiring visitor information from a visitor terminal held by a visitor;
displaying an image including the acquired visitor information on a screen; and
transmitting an unlocking command to an entranceway when an unlocking command of the entranceway is input after the image is displayed.

33. The information processing method according to claim 32, wherein
the visitor information includes an image of the visitor,
the information processing method further comprising,
by the information processing apparatus,
displaying the image of the visitor and an image captured by a camera installed in an intercom on an identical screen.

34. The information processing method according to claim 32, further comprising,
by the information processing apparatus:
further acquiring attribute information about the visitor as the visitor information; and
displaying the acquired attribute information about the visitor on the screen.

35. The information processing method according to claim 32, further comprising,
by the information processing apparatus,
changing a processing content by the visitor.

36-37. (canceled)
